(19) United States
(12) Patent Application Publication
(10) Pub. No.: US 2025/0051160 A1
(43) Pub. Date: Feb. 13, 2025

(54) REACTOR, SYSTEM AND METHOD FOR PROVIDING A HYDROGEN (H2) COMPOSITION

(71) Applicant: METHARC APS, Copenhgen (DK)

(72) Inventor: Stuart Robert GILLICK, Copenhagen (DK)

(21) Appl. No.: 18/717,597

(22) PCT Filed: Dec. 7, 2022
(86) PCT No.: PCT/EP2022/084756

§ 371 Date: Jun. 7, 2024

(30) Foreign Application Priority Data
Dec. 9, 2021 (DK) PA202101178

(51) Int. Cl. C01B 3/48; B01J 19/18; C01B 3/34; C25B 1/02; E21B 41/00

(52) U.S. Cl. CPC C01B 3/48; B01J 19/1812; C01B 3/34; C25B 1/02; E21B 41/00; C01B 2203/0238; C01B 2203/0283; C01B 2203/0838; C01B 2203/1235; C01B 2203/86

(57) ABSTRACT

The present invention relates to a wellbore reactor comprising a reaction chamber surrounded by a jacket, said reaction chamber comprises at least one carbon dioxide-inlet (CO₂-inlet), and/or at least one hydrocarbon-inlet, and at least one hydrogen-outlet (H₂-outlet).

### TECHNICAL FIELD OF THE INVENTION

The present invention relates to a system and method for providing hydrogen (H₂). In particular the present invention relates to a system and a method for producing and/or recovering hydrogen (H₂), e.g. from a hydrocarbon and/or water composition provided to a reactor from a sub-surface reservoir and/or obtained from above surface, in a productive, effective and environmentally friendly manner.

### BACKGROUND OF THE INVENTION

Hydrocarbons produced from sub-surface reservoirs has been used for centuries and such production involves that one or more wellbores are provided by boring into the Earth into an oil reservoir or a gas reservoir. Usually, some natural gas may be released as associated hydrocarbon gasses along with the bringing the oil to the surface. The wellbores are designed to bring hydrocarbons to the surface where the hydrocarbons may be further treated before final use.

The wellbores may be created by drilling concentric holes, e.g., with a diameter in the range of 12 cm to 1 meter, into the earth with a drilling rig that rotates a drill string with a bit attached.

After each wellbore section has been drilled, sections of steel pipe (casing), slightly smaller in diameter than the wellbore, are placed in the hole. Cement may be placed between the outside of the casing and the wellbore known as the annulus. The casing provides structural integrity to the newly drilled wellbore section, in addition to isolating potentially dangerous high-pressure zones from previous wellbore sections and from the surface.

With these zones safely isolated and the formation protected by the casing, the well can be drilled deeper (into potentially more-unstable and violent formations) with a smaller bit, and also cased with a smaller size casing. Modern wells often have two to five sets of subsequently smaller hole sizes drilled inside one another, each cemented with casing.

After drilling and casing the wellbore, the wellbore must be “completed”. Completion relates to the process in which the well is enabled to produce oil or gas.

In a cased-wellbore completion, small holes called perforations are made in the portion of the casing which passed through the reservoir zone, to provide a path for the oil to flow from the surrounding rock into the production tubing to surface (or vice versa for injection wells).

If no casing is placed and cemented across the reservoir zone, this is called an open hole completion. Often ‘sand screens’ or a ‘gravel pack’ is installed in the last drilled, uncased reservoir section. These maintain structural integrity of the wellbore in the absence of casing, while still allowing flow from the reservoir into the wellbore. However, these can, and often are, also used in cased hole completions if solids production from the reservoir is problematic.

After the completion is installed in the wellbore the well is ready for production from (or injection to) the reservoir. The reservoir fluids (typically a mixture of hydrocarbons & water) are produced through the tubing and safely processed at surface within specialised production facilities. The Completed wellbores allow for the regulation of pressure, flow rate control, data collection and production monitoring while also maintaining access to the reservoir (inside the tubing) with specialised equipment.

Before starting production from (or injection to) the reservoir, the drilling rig may be substituted with a processing rig for bringing the hydrocarbon composition to the surface, and which processing rig may be fitted with a collection of valves to regulate the flow of hydrocarbons from the sub-surface reservoir. These valves may regulate pressures, control flows, and allow access to the wellbore in case further completion work is needed.

From an outlet valve of the production rig, the flow can be connected to a processing facility or a distribution network of pipelines and tanks to supply the product to refineries, natural gas compressor stations, or oil export terminals.

If, after a period of production, the reservoir pressure depletes below a pressure that allows for the natural flow of fluids to surface, and it is considered economically viable, an artificial lift method can be employed (e.g., gas lift, pumps or turbines, where the fluids are pressure-assisted to reach surface).

The pressure depletion of reservoirs is often not the most efficient or effective way to recover the highest percentage of the hydrocarbon volume held within a reservoir.

Enhanced recovery methods (such as water flooding, steam flooding, or CO₂ flooding into the reservoir) may be used to increase the amount of hydrocarbon recovered from the reservoir. These methods simultaneously maintain reservoir pressure (or may increase it, if previous production has depleted the pressure below the original reservoir pressure) while also increasing recovery, by providing a “sweep” effect to push hydrocarbon volume out of the reservoir. Such pressure support or sweeping methods require the use of injection wellbores (either as dedicated injection wells or converted old production wells, which may not necessarily be drilled in a carefully pre-determined pattern), and may even be employed early in a field's life.

In addition to traditional hydrocarbon sources from sub-surface geological reservoirs, there is also the hydrocarbons developed from agricultural or bio-resources via the processing of biomass. Biomass is the term used to describe any fuel derived from plants. This includes crop residues, wood, crops and animal waste. Biogas is a mixture of methane (CH₄), CO₂ and small quantities of other gases produced by anaerobic digestion of the biomass organic matter in an oxygen-free environment. Biomethane (also known as “renewable natural gas”) is a near-pure source of methane produced either by “upgrading” biogas (a process that removes any CO₂ and other contaminants present in the biogas) or through the gasification of solid biomass followed by methanation.

The produced hydrocarbons may subsequently be used as an energy source, which may be burned in the presence of oxygen (O₂) producing carbon dioxide (CO₂) and water (H₂O), which may pollute the atmosphere and contribute significantly to climate change. Some of the hydrocarbons themselves (e.g., methane, CH₄) are also severely damaging greenhouse gases (GHG) when they escape to the atmosphere through equipment leaks during production, compression or transportation.

The challenge with the traditional ways of utilising hydrocarbons as an energy source is their high environmental impact due to emissions of methane (CH₄) to the atmosphere and carbon dioxide (CO₂) when burned. Both carbon dioxide (CO₂) and methane (CH₄) are highly potent greenhouse gases and the amount emitted to the atmosphere is slowly increasing. However, there is a desire from governments, industry and from the general population worldwide, to reduce the amount of carbon dioxide (CO₂) and methane (CH₄) emitted, and in addition to reduce the amount of carbon dioxide (CO₂) and methane (CH₄) presently in the atmosphere.

Hence, an improved system or method for producing an energy source (i.e., H₂) from a hydrocarbon composition and/or a carbon dioxide (CO₂) composition, obtained from above the surface or obtained from a sub-surface reservoir would be advantageous, and in particular a more efficient, productive, non-polluting, climate friendly, cleaner and/or more environmental system or method for producing an energy source (i.e., H₂) from a hydrocarbon composition and/or a carbon dioxide (CO₂) composition obtained from above the surface or obtained from the sub-surface reservoir would be advantageous.

### SUMMARY OF THE INVENTION

Thus, an object of the present invention relates to a system or a method for producing an energy source from a hydrocarbon composition and/or a carbon dioxide (CO₂) composition obtained from above the surface or obtained from the sub-surface reservoir.

In particular, it is an object of the present invention to provide a reactor, a system and/or a method for producing an energy source from a hydrocarbon composition and/or a carbon dioxide (CO₂) composition, e.g. obtained from the sub-surface reservoir and/or from above the surface, that solves the above mentioned problems of the prior art with emission of carbon dioxide (CO₂) and methane (CH₄) into the atmosphere causing serious environmental problems and global warming. The energy source may be produced in an effective, productive and environmentally friendly manner and also with the possibility for capturing externally supplied carbon dioxide (CO₂) and supplying said CO₂ to the reactor and/or to the sub-surface reservoir.

Thus, an aspect of the present invention relates to a reactor comprising a reaction chamber surrounded by a jacket, said reaction chamber comprises at least one carbon dioxide-inlet (CO₂-inlet), and/or at least one hydrocarbon-inlet, and at least one hydrogen-outlet (H₂-outlet).

A further aspect of the invention relates to a reactor comprising a reaction chamber surrounded by a jacket, said reaction chamber comprises at least one hydrocarbon-inlet, at least one hydrogen-outlet (H₂-outlet) and at least one carbon dioxide-outlet (CO₂-outlet).

Yet an aspect of the present invention relates to a system for producing a composition comprising hydrogen (H₂), the system comprising a processing rig, the processing rig comprises a reactor, the reactor is converting a hydrocarbon composition and/or a carbon dioxide (CO₂) composition at least partly into a composition comprising hydrogen (H₂).

Another aspect of the present invention relates to a system for producing a composition comprising hydrogen (H2), from a reactor in fluid communication with a sub-surface reservoir and/or with fluids injected from above the surface, the system comprising a processing rig, the processing rig comprises a reactor converting a hydrocarbon composition at least partly into a composition comprising hydrogen (H₂), and optionally wherein the system further comprises means for providing carbon capture of CO₂.

A further aspect of the present invention relates to a method for producing a composition comprising hydrogen (H₂), the method comprises the steps of:
(i) providing a starting composition, wherein the starting composition comprises a hydrocarbon composition and/or a carbon dioxide (CO₂) composition; and
(ii) subjecting the starting composition provided in step (i) to a conversion reaction within a reactor placed in a wellbore resulting in a composition comprising hydrogen (H₂)

Yet another aspect of the present invention relates to a method for producing a composition comprising hydrogen (H₂), the method comprises the steps of:
(i) providing a starting composition, wherein the starting composition comprises a hydrocarbon composition and/or a carbon dioxide (CO₂) composition;
(ii) subjecting the starting composition provided in step (i) to a conversion reaction resulting in a composition comprising hydrogen (H₂); and
(iii) injecting a composition comprising carbon dioxide (CO₂) into reservoir.

Still another aspect of the present invention relates to a method for reducing the emission of carbon dioxide (CO₂) to the atmosphere, the method comprises the steps of:
(i) providing a starting composition, wherein the starting composition comprises a hydrocarbon composition and/or a carbon dioxide (CO₂) composition;
(ii) subjecting the hydrocarbon composition provided in step (i) to a conversion reaction resulting in a composition comprising hydrogen (H₂) and a composition comprising carbon dioxide (CO₂); and
(iii) injecting the composition comprising carbon dioxide (CO₂) into reservoir.

Still another aspect of the present invention relates to a method for capturing externally provided, surface injected carbon dioxide (CO₂) together with internally produced carbon monoxide (CO) and/or carbon dioxide (CO₂) for reducing the emission of carbon dioxide (CO₂) to the atmosphere, the method comprises the steps of:
(i) providing a starting composition, wherein the starting composition comprises a hydrocarbon composition and/or a carbon dioxide (CO₂) composition;
(ii) subjecting the starting composition provided in step (i) to a conversion reaction incorporating externally provided, surface injected, carbon monoxide (CO) and/or carbon dioxide (CO₂) and resulting in a composition comprising hydrogen (H₂) and a composition comprising carbon monoxide (CO) and/or carbon dioxide (CO₂); and
(iii) injecting the composition comprising carbon monoxide (CO) and/or carbon dioxide (CO₂) directly into reservoir.

A preferred embodiment of the present invention relates to a system for producing a composition comprising hydrogen (H₂), the system comprising a processing rig, the processing rig comprises a reactor, the reactor is converting a hydrocarbon composition and/or a carbon dioxide (CO₂) composition at least partly into a composition comprising hydrogen (H₂).

Preferably, the hydrocarbon composition may be provided to the reactor from a sub-surface reservoir and/or from above surface.

Preferably, the carbon dioxide (CO₂) composition may be provided to the reactor from a sub-surface reservoir and/or from above surface, or produced during the reactor processing of the hydrocarbons.

A further aspect of the present invention relates to a system and/or a method for producing an energy source (e.g. hydrogen, H₂) from a hydrocarbon composition and/or a carbon dioxide (CO₂) composition, preferably comprising methane (CH₄) and/or carbon dioxide (CO₂), obtained from above surface, e.g. from the atmosphere and/or biomass processing, by above surface carbon capture. The composition obtained from above surface, may be processed within the wellbore reactor in conjunction with a geothermal reservoir or may be used to enhance the process for producing an energy source (e.g. hydrogen, H₂) from a hydrocarbon composition obtained from a sub-surface reservoir as described herein.

Yet an aspect of the present invention relates to the use of a reactor as described herein for converting a hydrocarbon composition at least partly into a composition comprising hydrogen (H₂).

A further aspect of the present invention relates to the use of geothermal energy in a wellbore as an energy source to assist in the conversion of a hydrocarbon composition and/or a carbon dioxide (CO₂) composition at least partly into a composition comprising hydrogen (H₂).

### BRIEF DESCRIPTION OF THE FIGURES

FIG. 1 shows a system according to the present invention comprising a reactor in fluid connection with a processing rig (processing rig is not shown in the figure) and the reactor may be in fluid contact to a sub-surface reservoir comprising oil, gas or water.

FIG. 2 shows a cross-sectional view (relative to the radial direction) of the reactor according to the present invention and the reactor may be illustrated, as a Taylor-Couette reactor with annular proton exchange capabilities, as a method for hydrogen (H₂) transportation or permeation to an outer annulus.

FIG. 3 shows a cross-sectional view (relative to the longitudinal direction) of the reactor according to the present invention and the reactor may be illustrated, as a Taylor-Couette reactor with annular proton exchange capabilities, as a method for hydrogen (H₂) transportation or permeation to an outer annulus, and

FIG. 4 shows a cross-sectional view (relative to the longitudinal direction) of the reactor within a wellbore according to the present invention comprising several separate zones. In particular FIG. 4 shows 5 separate zones.

FIG. 5 shows an example of a flow of streams from a sub-surface reservoir and/or a hydrocarbon composition and/or a carbon dioxide (CO₂) composition from above the surface (e.g. from carbon capture) for the production of hydrogen (H₂) using a system and a reactor according to the present invention, where a reactor according to the present invention are placed in the injection wellbore and/or in the production wellbore.

FIG. 6 shows a system according to the present invention comprising a reactor in fluid connection with a processing rig (processing rig is not shown in the figure) and the reactor may be in fluid contact with a sub-surface reservoir (sub-surface geothermal reservoir) where a hydrocarbon composition and/or a carbon dioxide (CO₂) composition from above the surface is provided to a reactor of the system producing hydrogen (H₂) taken advantage of the energy (e.g. the heat and pressure) of the geothermal reservoir.

The present invention will now be described in more detail in the following.

### DETAILED DESCRIPTION OF THE INVENTION

Accordingly, the inventor of the present invention surprisingly found a system and a method for producing an energy source from a hydrocarbon composition and/or a carbon dioxide (CO₂) composition obtained from a sub-surface reservoir and/or supplied from above the surface that reduces or even avoids emission of carbon dioxide (CO₂) and methane (CH₄) into the atmosphere reducing the serious environmental problems and the effects on global warming by providing an energy source in the form of a composition enriched wholly or partly in hydrogen (H₂) which may be produced in an effective, productive and environmental friendly manner.

In an embodiment of the present invention the hydrocarbon composition may include water, carbon dioxide (CO2) and dissolved gasses.

In a further embodiment of the present invention the carbon dioxide (CO₂) composition obtained from a sub-surface reservoir and/or supplied from above the surface may include water and other dissolved gasses.

A preferred embodiment of the present invention relates to a reactor comprising a reaction chamber surrounded by a jacket, said reaction chamber comprises at least one carbon dioxide-inlet (CO₂-inlet), and/or at least one hydrocarbon-inlet, and at least one hydrogen-outlet (H₂-outlet).

The reactor according to the present invention may further comprising at least one carbon dioxide-outlet (CO₂-outlet).

Yet a preferred embodiment of the present invention relates to a reactor comprising a reaction chamber surrounded by a jacket, said reaction chamber comprises at least one hydrocarbon-inlet, at least one hydrogen-outlet (H₂-outlet) and at least one carbon dioxide-outlet (CO₂-outlet).

A further preferred embodiment of the present invention relates to a reactor comprising a reaction chamber surrounded by a jacket, said reaction chamber comprises at least one carbon dioxide-inlet (CO₂-inlet), at least one hydrogen-outlet (H₂-outlet) and at least one carbon dioxide-outlet (CO₂-outlet).

An even further preferred embodiment of the present invention relates to a reactor comprising a reaction chamber surrounded by a jacket, said reaction chamber comprises at least one carbon dioxide-inlet (CO₂-inlet), at least one hydrocarbon-inlet, at least one hydrogen-outlet (H₂-outlet) and at least one carbon dioxide-outlet (CO₂-outlet).

In an embodiment of the present invention the reaction chamber may further comprise at least one water inlet (H₂O-inlet) and/or at least one air-inlet (O₂-inlet). The at least one water inlet (H₂O-inlet) and/or at least one air-inlet (O₂-inlet) may preferably be present when the reactor is to be used for injecting carbon dioxide (CO₂) into the reservoir. This may result in further production of the energy source, in particular hydrogen (H₂) by:
auto-thermal reforming, where syngas, comprising hydrogen and carbon monoxide, may be produced by partially oxidizing a hydrocarbon feed (such as methane (CH₄) and/or carbon dioxide (CO₂)) with oxygen, and/or
steam methane reforming wherein syngas (comprising hydrogen and carbon monoxide) may be produced by reaction of hydrocarbons with water.

The at least one hydrogen-outlet (H₂-outlet) and at least one carbon dioxide-outlet (CO₂-outlet) may be separated by a at least one proton exchange medium.

Preferably, the at least one hydrogen-outlet (H₂-outlet) and at least one hydrocarbon-inlet may be separated by at least one proton exchange medium.

In an embodiment of the present invention the at least one hydrogen-outlet (H₂-outlet) and at least one carbon dioxide-outlet (CO₂-outlet) and/or the at least one hydrocarbon-inlet may be separated by at least one proton exchange medium.

The at least one proton exchange medium according to the present invention may comprise solid oxides.

In an embodiment of the present invention the at least one proton exchange medium may separate hydrogen (H₂) from the carbon dioxide (CO₂) composition, the hydrocarbon composition, nitrogen, carbon monoxide, and/or carbon dioxide mixture by an electrochemical separation method. The electrochemical separation method may apply an electric current to a proton-conducting medium, hydrogen can be electrochemically dissociated on a catalyst of the anode, transported across the hydrated proton exchange medium, and then recovered on the catalytic cathode.

The at least one proton exchange medium according to the present invention may operate by hydrogen (H₂) at one side of the screen medium is split from being hydrogen (H₂) into protons (H⁺), as it is stripped of its' electron at the electrode, and the protons (H⁺) are then drawn and travel through the proton exchange medium to the other opposite electrode at the other side of the proton exchange medium where they collect electrons and reform to make hydrogen (H₂) again.

The at least one proton exchange medium containing either a proton-conducting electrolyte or dual ion-conducting electrolyte may be selected from the group consisting of an electrochemical hydrogen separator (EHS); a protonic ceramic electrochemical cell (PCEC); a solid oxide electrolysis cell (SOEC); a hybrid solid oxide electrolysis cell (H-SOEC); or a combination hereof.

The hydrocarbon composition, preferably in combination with water, may be transported from the at least one hydrocarbon-inlet (and/or a carbon dioxide (CO₂) inlet) into a reaction chamber where the hydrocarbon composition (together with the optional, externally sourced, surface injection of carbon dioxide, CO₂) may be converted to different reaction products, including hydrogen (H₂). The hydrogen (H₂) produced may then be transported through the at least one proton exchange medium to the hydrogen-outlet (H₂-outlet) of the reactor.

Similar reactions may be provided with a hydrocarbon composition and/or a carbon dioxide (CO₂) composition provided from above the surface that, preferably in combination with water, may be transported from the at least one hydrocarbon-inlet and/or the at least one carbon dioxide (CO₂) inlet, into a reaction chamber where the hydrocarbon composition and/or the carbon dioxide (CO₂) composition may be converted to different reaction products, including hydrogen (H₂). The hydrogen (H₂) produced may then be transported through the at least one proton exchange medium to the hydrogen-outlet (H₂-outlet) of the reactor.

In the reaction chamber gasification or reforming of the hydrocarbon composition and/or the carbon dioxide (CO₂) composition introduced may preferably be provided, resulting in the formation of hydrogen (H₂). The hydrogen (H₂) produced may subsequently diffuse through the at least one proton exchange medium to the at least one hydrogen-outlet (H₂-outlet).

The reactor may comprise a cylindrical construction or spinning disc. Preferably, the cylindrical construction may comprise two or more concentric elements. Preferably, the two or more concentric elements share the same centre or axis.

The cylindrical construction of the reactor may comprise:
two identical ends having similar cross-section from one end to the other; and
one curved side.

The cross-section of the reactor may be circular, polygonal shaped, sharing the same centre point.

The two or more concentric elements may provide the at least one hydrocarbon inlet, the at least one hydrogen-outlet (H₂-outlet), at least one carbon dioxide-outlet (CO₂-outlet), at least one carbon dioxide-inlet (CO₂-inlet), at least one water inlet (H₂O-inlet), and/or at least one oxygen-inlet (O₂-inlet).

Preferably, the at least one hydrogen-outlet (H₂-outlet) may be placed in the outer circumference of the reactor, preferably close to (or adjacent to) the jacket, e.g. in an outer annulus of the reactor.

In an embodiment of the present invention the hydrocarbon-inlet and/or the at least one carbon dioxide (CO₂) inlet may be placed closer to the centre of the reactor relative to the hydrogen-outlet (H₂-outlet).

In a preferred embodiment of the present invention hydrogen (H₂) may be collected from the at least one hydrogen-outlet (H₂-outlet).

The reactor according to the present invention may be provided with an energy unit. The energy unit may be provided to ensure sufficient energy in the reactor to promote, enhance, and/or control the reaction process (e.g. the gasification or reforming processes and the electrochemical processes) in the reactor.

The energy unit may comprise one or more energy units, such as 2 or more energy units, e.g. 3 or more energy units.

In an embodiment of the present invention the energy unit may be provided:
(i) between the hydrocarbon-inlet/the carbon dioxide-inlet and the hydrogen-outlet (H₂-outlet);
(ii) at the radial or longitudinal centre or either longitudinal ends of the reactor;
(iii) closer to the centre of the reactor relative to the hydrocarbon-inlet and the hydrogen-outlet (H₂-outlet); or
(iv) a combination of between the hydrocarbon-inlet/the carbon dioxide-inlet and the hydrogen-outlet (H₂-outlet) and at the centre or either ends of the reactor.

The energy unit may preferably be provided at the radial centre of the reactor.

The energy unit may comprise a rotating energy unit. The rotating unit may preferably be rotating around the centre axis of the reactor.

The flow of the fluid or gas stream obtained from the sub-surface reservoir and/or above surface injection may provide fully or partly the energy necessary for the rotation provided in the reactor and/or the energy unit.

In an embodiment of the present invention at least part of the necessary energy used for the gasification or reforming process may be provided from the reservoir in fluid communication with the wellbore. Preferably from the geothermal heat and pressure within the wellbore and/or in the reservoir.

It may be necessary to apply energy to the energy unit. Thus, to provide, and ensure, sufficient energy to the energy unit, energy may be provided from external sources, via an electrical cable. The external sources may preferably be obtained from wind power, solar power or the like.

It may also be necessary to export any excess energy from the energy unit to surface via the electric cable if more energy exists within the reactor than is required for the process to produce a composition comprising hydrogen (H₂). Heat energy recovery systems e.g., heat exchangers, turbo expanders, may be used to recover excess energy and/or convert it to electricity for export via the electric cable.

In an embodiment of the present invention the reactor may be divided into separate zones. The separate zones may have separate process conditions, e.g. the separate zones may have different temperatures and/or pressures; involve different chemical constituents, and/or different processing times. The zones may also include zones of different diameters and/or different lengths

The reactor may be divided into 1 or more zone, e.g. at least 2 separate zones, such as into at least 3 separate zones, e.g. as into at least 4 separate zones, such as into at least 5 separate zones, e.g. as into at least 7 separate zones, such as into at least 10 separate zones.

The different chemical constituents may be a difference in the relative concentration of the various constituents and/or a difference in the types of the chemical constituents present.

In an embodiment of the present invention, hydrogen (H₂) may be obtained from at least 1 zone of the reactor, such as at least 2 separate zones, e.g. at least 3 separate zones, such as at least 4 separate zones, e.g. at least 5 separate zones, such as at least 7 separate zones, e.g. at least 10 separate zones. Preferably, hydrogen (H₂) may be obtained from all the separate zones of the reactor.

A preferred embodiment of the present invention relates to a system for recovering a composition comprising hydrogen (H₂) from a reactor in fluid communication with a sub-surface reservoir, the system comprising a processing rig, the processing rig comprises a reactor converting a hydrocarbon composition at least partly into a composition comprising hydrogen (H₂), wherein the system further comprises means for providing carbon capture of CO₂.

In the present context the term “processing rig” may relate to a collection of surface equipment that receives the hydrogen and/or hydrocarbon composition flow stream exiting the wellbore at surface. This surface equipment may comprise processes to aid in; separation (into constituents), chemical or physical treatment, compression, or additional pumping of the hydrocarbon composition & it's constituents to storage, further processing or export & sale.

The reactor of the present invention may be used at the surface or placed at any depth within a wellbore. Preferably, the reactor may be used in the wellbore.

In an embodiment of the present invention the reactor according to the present invention may be adapted to be placed and used in a wellbore.

Preferably, the carbon dioxide (CO₂) captured by means for providing carbon capture of CO₂ may include the CO₂ naturally present in the hydrocarbon composition or produced from converting the hydrocarbon composition and/or the carbon dioxide (CO₂) composition at least partly into a composition comprising hydrogen (H₂) or carbon dioxide (CO₂) injected from above surface.

In an embodiment of the present invention the carbon dioxide (CO₂) captured according to the present invention (from the reservoir, the conversion of hydrocarbons to hydrogen, and/or introduced from an external source and injected from the surface/from above the surface) may also include carbon monoxide (CO).

Preferably, the composition comprising hydrogen (H₂) may be an organic composition comprising hydrogen (H₂).

According to the present invention the hydrocarbon composition and/or the carbon dioxide (CO₂) composition may at least partly be converted into a composition comprising hydrogen (H₂). The term “at least partly” may relates to at least 1% (w/w) of the hydrocarbon composition and/or the carbon dioxide (CO₂) composition may be converted into a composition comprising hydrogen (H₂), e.g. at least 5% (w/w), such as at least 10% (w/w), e.g. 20% (w/w), such as at least 30% (w/w), e.g. 40% (w/w), such as at least 50% (w/w), e.g. 60% (w/w), such as at least 70% (w/w), e.g. 80% (w/w), such as at least 90% (w/w), e.g. 95% (w/w), such as at least 97% (w/w), e.g. 99% (w/w).

The system according to the present invention may relate to a method for increasing the hydrogen content (the H₂ content) of a composition. Preferably, the composition comprising hydrogen (H₂) may be obtained from a reactor in fluid communication with a sub-surface reservoir.

The effect of the reactor may be enhanced by:
the geothermal heating alone (at sub-surface treatment, preferably in the wellbore);
geothermal heating in combination with heat pumps and/or heat exchangers (at the sub-surface, surface or super-surface treatment); or
the geothermal heating in combination with electrical heat (at sub-surface treatment or at the surface or super-surface treatment);
incorporation of catalyst materials;
the geological pore pressures alone (at sub-surface treatment);
geological pore pressures in combinations with the temperature combinations listed above; or
externally supplied, surface injected, carbon monoxide (CO) and/or carbon dioxide, (CO₂).

In the context of the present invention the terms “super-surface”, “at surface” and “above the surface” are used interchangeably and described a position at or above the surface of the earth and at sea above the seabed, and are used in contrast to the term “sub-surface”.

Preferably, the reactor according to the present invention is working at sub-surface conditions.

The reactor may be converting a hydrocarbon composition and/or a carbon dioxide (CO₂) composition at least partly into a composition comprising hydrogen (H₂).

The system according to the present invention may comprise means for injecting one or more hydrocarbon compositions, and/or carbon monoxide (CO) and/or carbon dioxide (CO₂) into the reservoir. The injection of the one or more hydrocarbon compositions, and/or carbon monoxide (CO) and/or carbon dioxide (CO₂) into any geological reservoir may be performed via:
the same well as the well for obtaining the hydrogen (H₂); and/or
a well different from the well for obtaining the hydrogen (H₂), but which well is in fluid communication with the well for obtaining the hydrogen (H₂); or
a well into any geological reservoir where hydrogen (H₂) is no longer generated or has ever been generated.

The geological reservoir (or a sub-surface geological reservoir) may be a sub-surface body of rock having sufficient porosity and permeability to store and transmit fluids.

Preferably, the carbon monoxide (CO) and/or carbon dioxide (CO₂) subjected to carbon capture may be carbon monoxide (CO) and/or carbon dioxide (CO₂) produced from the means for converting a hydrocarbon composition at least partly into a composition comprising hydrogen (H₂).

In an embodiment of the present invention, the carbon monoxide (CO) and/or carbon dioxide (CO₂) may also be provided from external sources (e.g. supplied from above the surface), or be a combination of carbon monoxide (CO) and/or carbon dioxide (CO₂) from externally sources in combination with carbon monoxide (CO) and/or carbon dioxide (CO₂) produced from the means for converting a hydrocarbon composition at least partly into a composition comprising hydrogen (H₂).

In an embodiment of the present invention the reactor converting the hydrocarbon composition at least partly into a composition comprising hydrogen (H₂) may be a reactor as described herein.

In yet an embodiment of the present invention the system according to the present invention may comprise means for capturing the composition comprising hydrogen (H₂).

The system according to the present invention may comprise means for separating, or partly separating hydrogen (H₂) from the composition.

In an embodiment of the present invention the system comprises means for capturing the composition comprising hydrogen (H₂); or the system comprises means for capturing the hydrogen (H₂).

Preferably, the composition comprising hydrogen (H₂), or enriched in hydrogen (H₂), comprises at least 1% (w/w) hydrogen (H₂), e.g. at least 5% (w/w) hydrogen (H₂), such as at least 10% (w/w), e.g. at least 15% (w/w), such as at least 20% (w/w), e.g. at least 25% (w/w), such as at least 30% (w/w), e.g. at least 40% (w/w), such as at least 50% (w/w), e.g. at least 60% (w/w), such as at least 70% (w/w), e.g. at least 80% (w/w), such as at least 85% (w/w), e.g. at least 90% (w/w), such as at least 95% (w/w), e.g. at least 98% (w/w).

In an embodiment of the present invention the reservoir may comprise water and water may be formed during the conversion of the hydrocarbon composition at least partly into a composition comprising hydrogen (H₂).

In yet an embodiment of the present invention the reactor converting a hydrocarbon composition and/or a carbon dioxide (CO₂) composition at least partly into a composition comprising hydrogen (H₂) may include means for performing electrolysis and/or means for performing gasification or reforming of the hydrocarbon composition and/or the carbon dioxide (CO₂) composition. Preferably the reactor converting a hydrocarbon composition and/or a carbon dioxide (CO₂) composition at least partly into a composition comprising hydrogen (H₂) may include means for performing gasification or reforming of the hydrocarbon composition and/or the carbon dioxide (CO₂) composition.

Preferably, the reactor may include means for performing electrolysis and/or means for performing gasification or reforming of the hydrocarbon composition.

The reactor may include means for performing electrolysis of the water supplied to the reactor from the water present in the reservoir; and/or water formed during the conversion of the hydrocarbon composition and/or the carbon dioxide (CO₂) composition; and/or water introduced from above the surface, at least partly into a composition comprising hydrogen (H₂).

The reactor may include means for performing gasification or reforming of the hydrocarbon composition and/or the carbon dioxide (CO₂) composition.

The means for performing electrolysis of the water phase, the means for performing gasification of the hydrocarbon composition and/or the carbon dioxide (CO₂) composition, the means for performing reforming of the hydrocarbon composition and/or the carbon dioxide (CO₂) composition, or the combination of the means for performing electrolysis of the water phase, the means for performing gasification of the hydrocarbon composition and/or the carbon dioxide (CO₂) composition and/or the means for performing reforming of the hydrocarbon composition and/or the carbon dioxide (CO₂) composition may result in a composition comprising hydrogen (H₂).

Electrolysis may be a technique that uses electric current to drive a non-spontaneous chemical reaction. According to the inventor of the present invention electrolysis may be commercially important as a stage in the preparation and/or separation of hydrogen (H₂) from hydrocarbon compositions, carbon dioxide (CO₂) compositions and/or water using an electrolytic cell or a fuel cell or an electrochemical hydrogen separation process

In an embodiment of the present invention, the reactor may comprise an electrochemical cell.

Preferably, the reactor comprises an electrochemical cell, in particular the electrochemical cell may be a fuel cell.

Electrolysis according to the present invention may be used in combination with increased temperature to improve conversion of the hydrocarbon composition and/or the carbon dioxide (CO₂) composition at least partly into a composition comprising hydrogen (H₂).

In a preferred embodiment of the present invention the reactor may be a Taylor-Couette Reactor.

In an embodiment of the present invention wherein the means for converting at least part of the hydrocarbon composition and/or the carbon dioxide (CO₂) composition to hydrogen (H₂) or the means for performing electrolysis may be a Taylor-Couette Reactor.

Preferably, the means for converting at least part of the hydrocarbon composition and/or the carbon dioxide (CO₂) composition to hydrogen (H₂) or the means for performing gasification or reforming may be a Taylor-Couette Reactor.

In an embodiment of the present invention the reactor according to the present invention, the means for converting at least part of the hydrocarbon composition and/or the carbon dioxide (CO₂) composition to hydrogen (H₂) and/or the means for performing electrolysis and the means for performing gasification or reforming may be a Taylor-Couette Reactor

The Taylor-Couette Reactor (TCR) may be an apparatus that has been designed to utilize the Taylor-Couette flow, which allows many flow regimes and conditions to perform as well as chemical conversions with precise control of various reactor characteristics.

The TCR may consist of a cylindrical shell in which a first (rotating) inner cylinder may be inserted so that a first annular gap may be formed.

In an embodiment of the present invention the concentric elements may be static or may individually rotate. Preferably, the concentric elements may be static.

In yet an embodiment of the present invention the first annular gap may constitute a reaction chamber of the hydrocarbon composition and/or the carbon dioxide (CO₂) composition.

In a further embodiment of the present invention, the hydrocarbon composition and/or the carbon dioxide (CO₂) composition may be introduced into the reactor's first annular gap through the at least one carbon dioxide-inlet (CO₂-inlet) and/or the at least one hydrocarbon-inlet.

The first annular gap may be in fluid connection with the at least one carbon dioxide-outlet (CO₂-outlet).

A second inner cylinder may be introduced providing a second annular gap (between the first inner cylinder and the second inner cylinder). In an embodiment of the present invention the second annular gap may be in fluid connection with the hydrogen-outlet (H₂-outlet) or may be separated from the hydrogen-outlet (H₂-outlet) by a proton exchange medium.

In one or more of the annular gaps of the TCR various flow regimes may be formed, resulting in significantly different flow conditions and shapes. The mixing conditions in a Taylor-Couette reactor may be set nearly independently from the axial flow by changing the rotational speed of the cylinders as well as the geometry of the reactor itself. The inventor of the present invention surprisingly found that the flow regime of the hydrocarbon composition and/or the carbon dioxide (CO₂) composition may be tailored specifically to the demand of the process—from mixing and dispersing due to high shear forces to high flow segregation resulting in a behaviour resulting in improved hydrogen (H₂) production and resulting in a composition comprising increased content of hydrogen (H₂).

It has also been shown in other industries that TCR processing during chemical manufacture may also control the size of chemical crystallisation initiation sites, and so the rates of crystallisation for the precipitation of any carbonates produced during this process may be controlled and delayed significantly, reducing the risk to blocking the geological reservoirs pore space within the wellbore region. The chemicals injected into the reservoir to assist the control of carbonate precipitation may include sodium hydroxide (NaOH), sodium bicarbonate (NaHCO₃); sodium carbonate (Na₂CO₃), or a combination hereof. The sodium hydroxide (NaOH) supply to the reactor may be to enhance the carbon capture through the formation of carbonates and bicarbonates when the sodium hydroxide (NaOH) reacts with the carbon monoxide (CO) and/or carbon dioxide (CO₂) prior to being injected into the reservoir where they are allowed to eventually precipitate.

A preferred embodiment of the present invention includes means for converting at least part of the hydrocarbon composition and/or the carbon dioxide (CO₂) composition to a composition comprising hydrogen (H₂), e.g. the reactor as described herein, wherein the means for converting at least part of the hydrocarbon composition and/or the carbon dioxide (CO₂) composition to a composition comprising hydrogen (H₂), e.g. the reactor as described herein may be adapted to be used at surface or in a wellbore, preferably, the reactor according to the present invention may be used in a wellbore. Preferably, the means for converting at least part of the hydrocarbon composition and/or the carbon dioxide (CO₂) composition to a composition comprising hydrogen (H₂), e.g. the reactor as described herein may have a cylindrical construction, in particular an open cylindrical construction.

In an embodiment of the present invention the cylindrical construction may comprise:
two identical ends having similar cross-section from one end to the other; and
one curved side.

Preferably, the reactor may be placed at least 100 meters sub-surface, such as at least 150 meters sub-surface, e.g. at least 250 meters sub-surface, such as at least 500 meters sub-surface, e.g. at least 750 meters sub-surface, such as at least 1000 meters sub-surface, e.g. at least 1500 meters sub-surface, such as at least 2000 meters sub-surface, e.g. at least 2500 meters sub-surface, such as at least 5000 meters sub-surface.

In an embodiment of the present invention the reactor may be at least 100 meters below the processing rig, such as at least 150 meters below the processing rig, e.g. at least 250 meters below the processing rig, such as at least 500 meters below the processing rig, e.g. at least 750 meters below the processing rig, such as at least 1000 meters below the processing rig, e.g. at least 1500 meters below the processing rig, such as at least 2000 meters below the processing rig, e.g. at least 2500 meters below the processing rig, such as at least 3000 meters below the processing rig, e.g. at least 3500 meters below the processing rig, such as at least 4000 meters below the processing rig, e.g. at least 4500 meters below the processing rig, such as at least 5000 meters below the processing rig.

The means for providing carbon capture according to the present invention may relate to the process of capturing carbon monoxide (CO) and/or the carbon dioxide (CO₂) before the carbon monoxide (CO) and/or the carbon dioxide (CO₂) originally present in the hydrocarbon composition or the carbon monoxide (CO) and/or the carbon dioxide (CO₂) produced during the conversion of the hydrocarbon composition (or parts hereof) into the composition, enters the atmosphere.

Carbon monoxide (CO) and/or the carbon dioxide (CO₂) may also be provided from an externally supplied source where carbon monoxide (CO) and/or the carbon dioxide (CO₂) may not be originating from the reservoir or the hydrocarbon composition, but may be provided from above surface, e.g. from the atmosphere, industrial processes by-products, or biomass processing, by above surface carbon capture.

Preferably, the carbon monoxide (CO) and/or carbon dioxide (CO₂) originally present in the hydrocarbon composition, or produced during the conversion of the hydrocarbon composition (or parts hereof), or provided from an externally supplied above surface source may be transported to and stored in the same reservoir as the reservoir the hydrocarbon composition was obtained, or it may be transported and stored in a different reservoir. Preferably, the carbon dioxide (CO₂) originally present in the hydrocarbon composition or produced during the conversion of the hydrocarbon composition (or parts hereof) or provided from an externally supplied above surface source may be stored in the same reservoir.

In a preferred embodiment of the present invention the reactor is, during operation, placed sub-surface. Preferably, the reactor may be placed sub-surface at any depth within the wellbore. Preferably, the reactor may not be placed within the reservoir, but within the wellbore between the reservoir and the surface.

Preferably, sub-surface relates to a position of the reactor below the surface of the earth, and at sea below the seabed.

The position of the reactor may preferably be at least 100 meters sub-surface, such as at least 150 meters sub-surface, e.g. at least 250 meters sub-surface, such as at least 500 meters sub-surface, e.g. at least 750 meters sub-surface, such as at least 1000 meters sub-surface, e.g. at least 1500 meters sub-surface, such as at least 2000 meters sub-surface, e.g. at least 2500 meters sub-surface, such as at least 3000 meters sub-surface, e.g. at least 3500 meters sub-surface, such as at least 4000 meters sub-surface, e.g. at least 4500 meters sub-surface, such as at least 5000 meters sub-surface.

Preferably, the sub-surface may relate to deep hydrocarbon drilling or geothermal drilling.

In an embodiment of the present invention the reaction of the hydrocarbon composition and/or the carbon dioxide (CO₂) composition to the composition comprising hydrogen (H₂) may include gasification or reforming of the hydrocarbon composition and/or the carbon dioxide (CO₂) composition at elevated temperatures.

The reaction of the hydrocarbon composition and/or the carbon dioxide (CO₂) composition to the composition comprising hydrogen (H₂), e.g. the gasification or reforming process, may require a significant amount of heat.

A significant amount of heat necessary to drive the reaction of the hydrocarbon composition and/or the carbon dioxide (CO₂) composition to the composition comprising hydrogen (H₂), e.g. the gasification or reforming process, may be above the minimum chemical reaction activation energy, and may be in the range of 100-1200° C., e.g. in the range of 500-1000° C., such as in the range of 650-850° C., such as in the range of 675-775° C., e.g. about 700° C.

In an embodiment of the present invention the reactor performance may be further improved by the wellbore pressure which, when the reactor is also in fluid communication with the reservoir, may be dependent on various parameters like, the depth of the wellbore (or the depth of the reactor in the wellbore), on the particular sub-surface reservoir, the location of the sub-surface reservoir; the different rock types surrounding the sub-surface reservoir and/or the wellbore, the different fluid/gas content, the geological structure, and/or formation thickness, etc.

The inventor of the present invention surprisingly found that geothermal heating and/or geological pore pressure may be used as an energy source, or as a significant contribution, to provide energy to accelerate the reaction of the hydrocarbon composition and/or the carbon dioxide (CO₂) composition to the composition comprising hydrogen (H₂), e.g. the gasification or reforming process, resulting in a significant reduction in production costs.

In an embodiment of the present invention the reactor according to the present invention may be placed in the wellbore between the surface and a geothermal reservoir. Preferably, a reactor according to the present invention may be placed in the wellbore between the surface and a geothermal reservoir and a composition comprising the hydrocarbon composition and/or the carbon dioxide (CO₂) composition may be supplied from above the surface to the reactor.

Preferably, the carbon dioxide (CO₂) composition supplied from above the surface may comprise carbon dioxide (CO₂), or the combination of carbon dioxide (CO₂), water and carbon monoxide (CO).

Preferably, the hydrocarbon composition supplied from above the surface may comprise methane and water.

In an embodiment of the present invention the composition supplied from above the surface may comprise the combination of carbon dioxide (CO₂), water and methane. In another embodiment of the present invention the composition supplied from above the surface comprises the combination of carbon dioxide (CO₂), methane, water and carbon monoxide (CO).

The geothermal heating and/or geological pore pressure may come from geothermal energy and is energy from the interior of the earth. The geothermal energy is considered to originate from the formation of the planet and from radioactive decay of materials. The high temperature and pressure in Earth's interior may cause some rock to melt and solid mantle to behave plastically, resulting in parts of the mantle convecting upward since it is lighter than the surrounding rock and temperatures at the core-mantle boundary can reach over 4000° C.

Geothermal heating and/or geological pore pressure, for example using water from hot springs has been used for bathing since Palaeolithic times and for space heating since ancient Roman times, however more recently geothermal power, the term used for generation of electricity from geothermal energy, has gained in importance. It is estimated that the earth's geothermal resources are theoretically more than adequate to supply humanity's energy needs, although only a very small fraction is currently being profitably exploited, often in areas near tectonic plate boundaries.

When recovering water from water reservoirs, hydrocarbons compositions from gas reservoirs or from oil reservoirs, the depth of the reservoir may determine the temperature, pressure and the geothermal energy. Typically, the deeper the reservoir is located below the earth surface, the higher the geothermal energy and the higher the temperature.

Thus, the inventor of the present invention surprisingly found a way to exploit the geothermal energy in the generating a composition comprising hydrogen (H₂). The generation of the composition comprising hydrogen (H₂) may preferably be provided together with a reduced discharge or emission of greenhouse gasses (GHG) like carbon dioxide (CO₂) and/or methane (CH₄). This may be further improved with the addition of the surface injection of carbon monoxide (CO) and/or carbon dioxide (CO₂) from external supplied sources.

In an embodiment of the present invention the sub-surface reservoir or the sub-surface geological reservoir may be a liquid hydrocarbon reservoir, e.g. an oil reservoir (a sub-surface oil reservoir), a gaseous hydrocarbon reservoir, e.g. a gas or condensate reservoir (a sub-surface gas reservoir), or a geothermal reservoir (a sub-surface geothermal reservoir).

A preferred embodiment of the present invention relates to a method for producing a composition comprising hydrogen (H₂), the method comprises the steps of:
(i) providing a starting composition, wherein the starting composition comprises a hydrocarbon composition and/or a carbon dioxide (CO₂) composition; and
(ii) subjecting the starting composition provided in step (i) to a conversion reaction in a wellbore reactor resulting in a composition comprising hydrogen (H₂)

In an embodiment of the present invention the starting composition provided in step (i) may be subjected to a conversion reaction in a wellbore reactor resulting in a composition comprising hydrogen (H₂) and a composition comprising carbon monoxide (CO) and/or carbon dioxide (CO₂).

Preferably, the composition comprising carbon monoxide (CO) and/or carbon dioxide (CO₂) may be injected into a sub-surface reservoir. Preferably, the injection of the composition comprising carbon monoxide (CO) and/or carbon dioxide (CO₂) may be into the same sub-surface reservoir where at least part of the starting material was obtained (as some starting material may be obtain from above surface injection)

The conversion reaction resulting in a composition comprising hydrogen (H₂), and optionally a composition comprising carbon monoxide (CO) and/or carbon dioxide (CO₂) may be performed in a reactor according to the present invention.

A preferred embodiment of the present invention relates to a method for producing a composition comprising hydrogen (H₂), the method comprises the steps of:
(i) providing a starting composition, wherein the starting composition comprises a hydrocarbon composition and/or a carbon dioxide (CO₂) composition;
(ii) subjecting the starting composition provided in step (i) to a conversion reaction within a wellbore reactor resulting in a composition comprising hydrogen (H₂); and
(iii) injecting a composition comprising carbon monoxide (CO) and/or carbon dioxide (CO₂) into a reservoir.

Another preferred embodiment of the present invention relates to a method for reducing the emission of carbon monoxide (CO) and/or carbon dioxide (CO₂) to the atmosphere, the method comprises the steps of:
(i) providing a starting composition, wherein the starting composition comprises a hydrocarbon composition and/or a carbon dioxide (CO₂) composition;
(ii) subjecting the starting composition provided in step (i) to a conversion reaction within a wellbore reactor resulting in a composition comprising hydrogen (H₂) and a composition comprising carbon monoxide (CO) and/or carbon dioxide (CO₂); and
(iii) injecting the composition comprising carbon monoxide (CO) and/or carbon dioxide (CO₂) directly into a reservoir.

In an embodiment of the present invention the hydrocarbon composition may be provided from a sub-surface geological reservoir or injected from above surface.

The composition comprising carbon monoxide (CO) and/or carbon dioxide (CO₂) may be provided from the reservoir and/or produced from the conversion reaction of the hydrocarbon composition resulting in a composition comprising hydrogen (H₂) and a composition comprising carbon monoxide (CO) and/or carbon dioxide (CO₂).

Preferably, the composition comprising carbon monoxide (CO) and/or carbon dioxide (CO₂) may be injected directly into a reservoir.

In an embodiment of the present invention the conversion of the hydrocarbon composition into a composition comprising hydrogen (H₂) may be performed in a reactor. Preferably, the reactor is a reactor according to the present invention.

Preferably, the composition comprising carbon monoxide (CO) and/or carbon dioxide (CO₂) may be injected directly into the reservoir. Preferably, the composition comprising carbon monoxide (CO) and/or carbon dioxide (CO₂) may be injected directly from the reactor into the reservoir.

Injecting directly into the reservoir may include addition of necessary piping or equipment used to convey the composition comprising carbon monoxide (CO) and/or carbon dioxide (CO₂) into the reservoir. This injection may also include the surface injection of externally supplied carbon monoxide (CO) and/or carbon dioxide (CO₂).

Preferably, the composition comprising carbon monoxide (CO) and/or carbon dioxide (CO₂) does not leave the system according to the present invention, comprising a processing rig and a reactor converting a hydrocarbon composition and/or a carbon dioxide (CO₂) composition at least partly into a composition comprising hydrogen (H₂), and wellbore piping whereby the composition comprising carbon monoxide (CO) and/or carbon dioxide (CO₂) is not allowed to leave the system into the atmosphere.

Even more preferably, the composition comprising carbon monoxide (CO) and/or carbon dioxide (CO₂) does not leave the wellbore at the surface of the earth.

In an embodiment of the present invention the reactor may be placed in a wellbore forming a pathway between the reservoir and a processing rig.

In yet an embodiment of the present invention the system according to the present invention comprises a processing rig in fluid communication with a reservoir via a first wellbore allowing the production of the obtained composition comprising hydrogen (H₂). The system may further comprise a second (or multilateral) wellbore, said second (or multilateral) wellbore providing an alternative fluid connection between the reservoir and the processing rig allowing injection of greenhouse gasses, like carbon dioxide (CO₂) and/or methane (CH₄).

The second (or multilateral) wellbore providing an alternative fluid connection between the reservoir and the processing rig may also allow injection of water and/or chemicals into the reservoir. The chemicals injected into the reservoir may control the rates of carbonate precipitation and may include sodium hydroxide (NaOH), sodium bicarbonate (NaHCO₃); sodium carbonate (Na₂CO₃), or a combination hereof.

In an embodiment of the present invention the first wellbore may comprise a reactor according to the present invention and/or the second (or multilateral) wellbore may comprise a reactor according to the present invention.

The conversion of the hydrocarbon composition resulting in a composition comprising hydrogen (H₂) may include gasification or reforming of the hydrocarbon composition and/or the carbon dioxide (CO₂) composition.

In yet an embodiment of the present invention the reactor may provide a temperature of the hydrocarbon composition and/or the carbon dioxide (CO₂) composition in the range of 100-1200° C., e.g. in the range of 500-1000° C., such as in the range of 650-850° C., such as in the range of 675-775° C., e.g. about 700° C.

The reservoir may comprise water, water that may be added from surface, and/or water that may be produced from the conversion of the hydrocarbon composition and/or the carbon dioxide (CO₂) composition resulting in a composition comprising hydrogen (H₂).

This water may be subjected to means for performing electrolysis generating additional hydrogen (H₂) The reactor according to the present invention may comprise a rotating energy unit. The rotating unit may preferably be rotating around the centre axis of the reactor. In an embodiment of the present invention the reactor may be a Taylor-Couette reactor.

In an embodiment of the present invention the reactor may provide a rotation in the range of 100-10,000 rpm, such as in the range of 500-8,000 rpm; e.g. in the range of 1,000-6,000 rpm; such as in the range of 1500-5,000 rpm; e.g. in the range of 2,000-4,000 rpm; such as in the range of 2500-3,500 rpm; e.g. about 3,000 rpm.

In an embodiment of the present invention the method comprises the further step:
(iv) surface injection of an externally supplied source of hydrocarbons and/or carbon monoxide (CO) and/or carbon dioxide (CO₂), e.g. collected from a separate carbon capturing process, and/or methane (CH₄) captured from industry, biological waste processing or from the atmosphere, into the wellbore reactor and further into the reservoir.

In an embodiment of the present invention the externally supplied source of hydrocarbons and/or carbon monoxide (CO) and/or carbon dioxide (CO₂) and the hydrocarbons and/or carbon monoxide (CO) and/or carbon dioxide (CO₂) from above the surface, may be the same.

In the method according to the present invention the conversion reaction resulting in a composition comprising hydrogen (H₂), and a composition comprising carbon monoxide (CO) and/or carbon dioxide (CO₂) may be performed, and wherein the resulting composition comprising carbon monoxide (CO) and/or carbon dioxide (CO₂) may be injected from the reactor and further into the reservoir. The method comprises the steps of:
(i) providing a starting composition, wherein the starting composition comprises a hydrocarbon composition and/or a carbon dioxide (CO₂) composition;
(ii) subjecting the starting composition provided in step (i) to a conversion reaction within a wellbore reactor resulting in a composition comprising hydrogen (H₂) and a composition comprising carbon monoxide (CO) and/or carbon dioxide (CO₂); and
(iii) injecting the composition comprising carbon monoxide (CO) and/or carbon dioxide (CO₂) directly into a reservoir.

In a further embodiment of the present invention an externally supplied, above surface injected carbon monoxide (CO) and/or carbon dioxide, (CO₂) may be introduced into the reactor's first annular gap through at least one carbon dioxide (CO2) and/or hydrocarbon-inlet, and at least one water-inlet (H₂O-inlet) and/or at least one oxygen-inlet (O₂-inlet).

A preferred embodiment of the present invention relates to the use of geothermal energy in a wellbore as an energy source for converting a hydrocarbon composition and/or a carbon dioxide (CO₂) composition at least partly into a composition comprising hydrogen (H₂).

The use according to the present invention wherein the use may be achieved by installing the reactor according to the present invention in the wellbore.

It should be noted that embodiments and features described in the context of one of the aspects of the present invention also apply to the other aspects of the invention.

The invention will now be described in further details in the following detailed description of the figures.

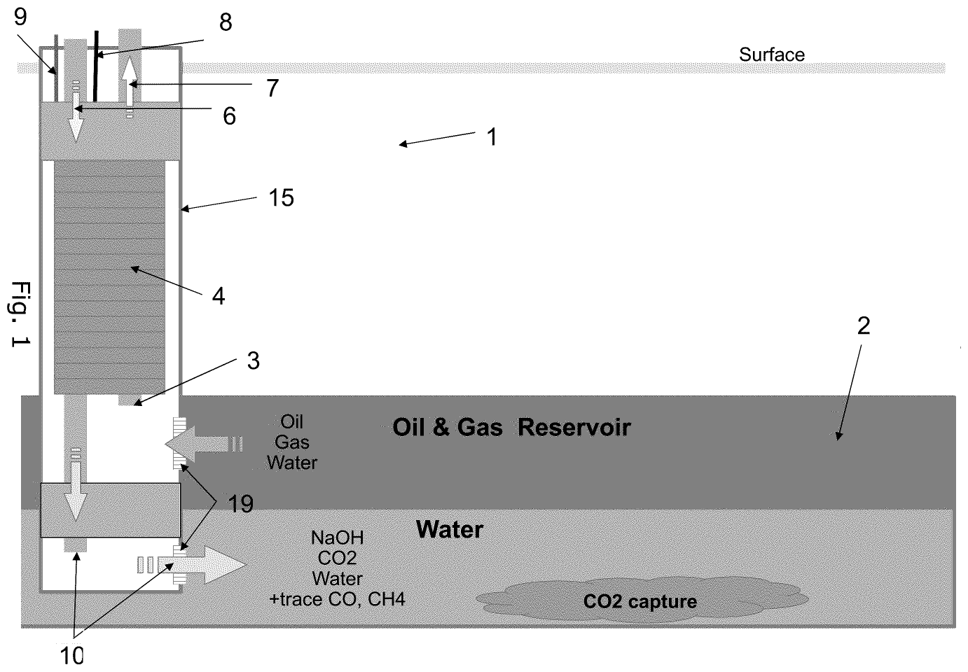

FIG. 1 shows part the system (1) according to the present invention, however, the processing rig, which forms part of the system and being in fluid contact with the reactor (4) is not shown in the figure. The reactor (4) may be capable of converting a hydrocarbon composition obtained from a sub-surface reservoir (2) such as a liquid hydrocarbon reservoir, e.g. an oil reservoir (a sub-surface oil reservoir), or a gaseous hydrocarbon reservoir, e.g. a gas or condensate reservoir (a sub-surface gas reservoir). The hydrocarbon composition of the sub-surface reservoir (2) may be transported from the sub-surface reservoir (2) into the reactor via perforation (19) filtering solid matter from the hydrocarbon composition when entering the reactor through the hydrocarbon-inlet (3). The reactor may be placed on the processing rig or in a wellbore sub-surface below the processing rig. Preferably, the reactor may be placed in a wellbore (15) sub-surface below the processing rig. Even more preferably, the reactor may be placed in the wellbore (15) close to the reservoir (2).

In the reactor (4) gasification of the hydrocarbon composition may be performed and a composition comprising hydrogen (H₂) may be provided. The composition comprising hydrogen (H₂) may leave the reactor (4) via at least one hydrogen-outlet (H₂-outlet) (7) Following which the hydrogen (H₂) or the composition comprising hydrogen (H₂) may be collected.

Carbon dioxide (CO₂) and/or carbon monoxide (CO) produced in the reactor (4), e.g. from gasification, reforming and/or electrolysis, may be captured and reintroduced into the sub-surface reservoir via the carbon dioxide-outlet (CO2-outlet) (10) via perforations (19) preventing them reaching the atmosphere—thus resulting in a carbon capture process of the carbon dioxide (CO₂) originally present in the hydrocarbon composition or the carbon dioxide (CO₂) produced during the conversion of the hydrocarbon composition (or parts hereof) into the composition.

Additional carbon dioxide (CO₂) and/or methane may be provided from external supplied above surface sources (6), like CO₂ and/or methane captured from e.g. the atmosphere, biological waste processing or from industrial exhaust gasses. This carbon dioxide (CO₂) and/or methane from external above surface sources may be supplied to the reactor (4) via the carbon dioxide-inlet (CO₂-inlet) (6). This addition of external carbon dioxide (CO₂) and/or methane may further improve the productivity of the conversion of the hydrocarbon composition (3) at least partly into a composition comprising hydrogen (H₂). The reason for this improved conversion of the hydrocarbon composition at least partly into a composition comprising hydrogen (H₂) may be caused by the balancing of the collective equilibrium of the gasification or reforming reactions:

CₙH₍₂ₙ₊₂₎+CO₂⇄H₂+CO+H₂O

The temperature necessary for the gasification reaction to take place may be in the range of 600-800° C. The energy necessary to provide a temperature in the range of 600-800° C. in order for the gasification or reforming reaction to take place may preferably be provided from geothermal energy, however electrical energy may be provided (via an electric cable (8) from surface) to ensure sufficient energy for adjusting and maintaining the desired temperature and/or for reaching the minimum activation energies to initiate the exothermic reactions. These exothermic chemical gasification or reforming reactions may be sufficient to maintain the reactor temperatures once gasification or reforming commences. If the temperature and pressure are sufficient for the water and/or CO₂ to reach their supercritical phase this may lower the overall energy requirements for the gasification or reforming and improve energy efficiencies.

The electrical energy, as well as the electricity provided and necessary for the electrolysis and reactor, may be provided from the processing rig and may be produced from green energy, like wind power, wave or ocean current power, or the like. The electricity may be provided to the reactor from the processing rig by an electric cable (8). This electric cable (8) may also serve to export excess energy from the reactor to surface when required.

The remaining carbon dioxide (CO₂) not reacted in the gasification or reforming reaction (coming from external above surface sources; naturally present in the hydrocarbon composition; and produced during the reactions in the reactor (4)), may, together with e.g. carbon monoxide (CO), and water, be injected, via the carbon dioxide-outlet (10) into the reservoir. After this reinjection into the sub-surface reservoir any remaining trace carbon monoxide (CO) may react with water, at about 180-500° C., forming hydrogen (H₂) and carbon dioxide (CO₂) following the following water gas shift reaction (WGSR):

CO+H₂O⇄H₂+CO₂

From this reaction additional hydrogen (H₂) may be formed which may be retained within and later recovered from the sub-surface reservoir.

The energy necessary to provide a temperature in the range of 180-500° C. in order for the water gas shift reaction (WGSR) to take place may preferably be provided from geothermal energy.

A sodium hydroxide-inlet (NaOH-inlet) (9) may be provided and the sodium hydroxide-inlet (9) may be in fluid contact with the processing rig. The sodium hydroxide-inlet (9) may supply sodium hydroxide (NaOH) to the reactor (4) to enhance the carbon capture through the formation of carbonates and bicarbonates when the sodium hydroxide (NaOH) reacts with the carbon monoxide (CO) and/or carbon dioxide (CO₂) prior to being injected into the reservoir to where they are allowed to eventually precipitate.

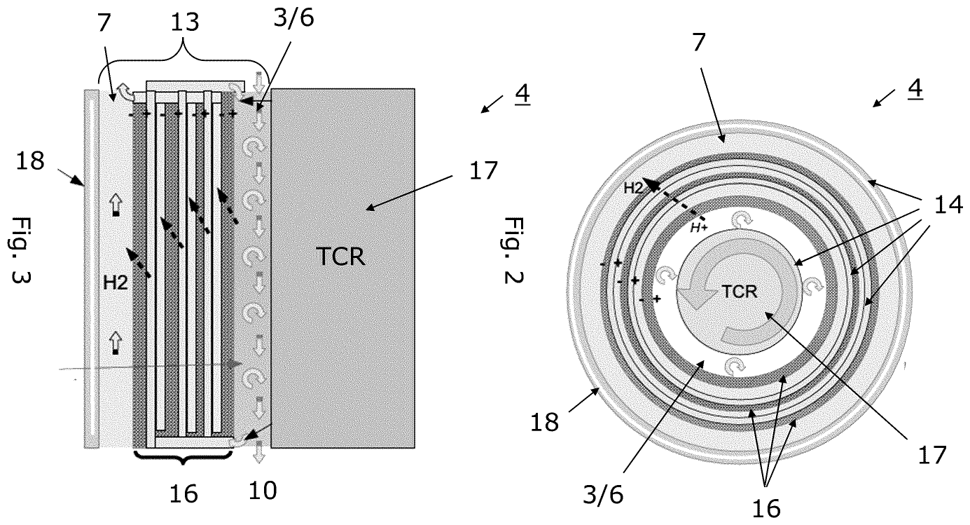

FIGS. 2 and 3 shows a cross-sectional view—relative to the radial direction (FIG. 2) and a cross-sectional view in the longitudinal direction (FIG. 3), of the reactor (4) according to the present invention. The reactor being a Taylor Couette reactor. The reactor (4) comprises a reaction chamber (13) surrounded by a jacket (18), said reaction chamber (13) comprises at least one carbon dioxide-inlet (CO₂-inlet) (6) and/or at least one hydrocarbon-inlet (3), at least one hydrogen-outlet (H₂-outlet) (7) and at least one carbon dioxide-outlet (CO₂-outlet) (10); and an energy unit (17). The at least one hydrogen-outlet (H2-outlet) (7) and at least one carbon dioxide-outlet (CO₂-outlet) (10) may be separated by an at least one proton exchange medium (16).

The reaction chamber (13) may comprise a cylindrical construction (14) may comprise two or more concentric elements (14). The two or more concentric elements (14) may preferably share the same centre or axis. The reactor shown in FIG. 2 comprises 4 concentric elements (14) and only the inner most concentric element (17) may be rotating creating a turbulent flow of the hydrocarbon composition, but one or more of the other concentric elements (14) may also be rotating.

During operation the hydrocarbon composition is introduced into the reaction chamber (13) via the hydrocarbon-inlet (3). Parameters like temperature, pressure and turbulent flow allows the gasification or reformation reaction to convert at least part of the hydrocarbon composition into a composition comprising hydrogen (H₂). The hydrogen (H₂) may be transported through the at least one proton exchange medium (16) and further towards the hydrogen-outlet (H₂-outlet) (7) where the composition comprising hydrogen (H₂) may be collected. The hydrogen-outlet (H₂-outlet) (7) is placed in the outer periphery of the cylindrical reactor (4), close to the jacket (18)

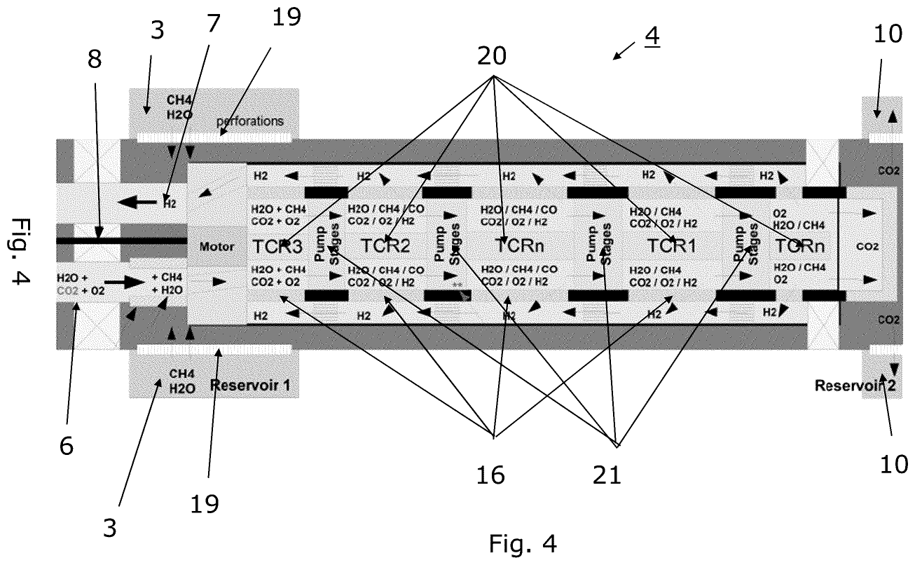

FIG. 4 show a Taylor-Couette reactor (4) according to the present invention comprising 5 separate zones (20) for converting a hydrocarbon composition at least partly into a composition comprising hydrogen (H₂). The separate zones (20) may have separate process conditions, e.g. the separate zones may have different temperatures and/or pressures; involve different chemical constituents, different concentrations of chemical constituents, and/or different processing times. Hydrogen (H₂) produced in the reactor (4) may be obtained from at least all 5 zones and may be transferred over the proton exchange medium (16) and may be further transferred to the hydrogen-outlet (H₂-outlet) (7) where it may be collected. The carbon dioxide (CO₂) naturally present in the hydrocarbon composition or formed during the conversion of the hydrocarbon composition at least partly into a composition comprising hydrogen (H₂), or an externally supplied source of carbon monoxide (CO) and/or carbon dioxide (CO₂) and/or methane added via the carbon dioxide-inlet (CO₂-inlet) (6) into the reactor (4), may further boost the conversion and development of hydrogen (H₂). The carbon dioxide (CO₂) may leave the reactor through the carbon dioxide-outlet (CO₂-outlet) (10) and preferably into the sub-service reservoir.

The reactor (4) may comprise perforations (19) filtering solid matter from the hydrocarbon composition before entering the reactor (4).

Between the separate zones (20) of the reactor (4) pumps, turbines, turbo-expanders, sparges, or the like (21) may be provided to transfer and to simultaneously reduce the temperature and/or pressure of the hydrocarbon composition between the separate successive zones.

The hydrocarbon composition (3) may be obtained from reservoir 1 and enter the reactor (4) where the hydrocarbon composition may be converted at least partly into a composition comprising hydrogen (H₂). The carbon dioxide (CO₂) obtained may be transferred to the carbon dioxide-outlet (CO₂-outlet) (10) and exit the reactor into reservoir 2.

In an embodiment of the present invention the reservoir 1 and reservoir 2 may be two different reservoirs not being in fluid communication.

In yet an embodiment of the present invention the reservoir 1 and reservoir 2 may be the same reservoir using the same wellbore.

In a further embodiment of the present invention the reservoir 1 and reservoir 2 may be the same reservoir however two different multilateral or individual wellbores are used but the two multilateral or individual wellbores are in fluid contact.

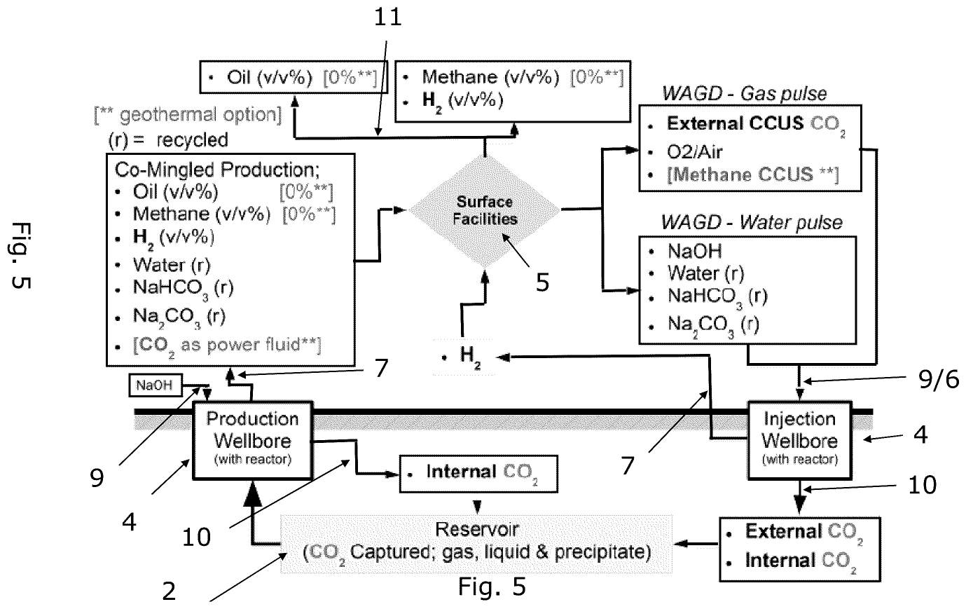

FIG. 5 shows an example of a flow of streams from a sub-surface reservoir (2) to a production rig having various surface facilities (5), describing two wellbores (the number of wellbores may be changed by the skilled person depending on the needs) originating from one or more wells having each a reactor (4) inserted in said wellbore. The first reactor (4), on the left-hand side provides a production wellbore where at least one hydrogen-outlet (H₂-outlet) (7) has been provided allowing the extraction of a composition comprising hydrogen (H₂). The composition comprising hydrogen (H₂) may be obtained from the reactor (4) converting a hydrocarbon composition at least partly into the composition comprising hydrogen (H₂). The composition comprising hydrogen (H₂) may also comprise other components like oil, methane, water, carbonates, carbon monoxide (CO) and carbon dioxide (CO₂). The content of hydrogen (H₂) in the composition comprising hydrogen (H₂) may preferably comprise at least 1% (w/w) hydrogen (H₂), e.g. at least 5% (w/w) hydrogen (H₂), such as at least 10% (w/w), e.g. at least 15% (w/w), such as at least 20% (w/w), e.g. at least 25% (w/w), such as at least 30% (w/w), e.g. at least 40% (w/w), such as at least 50% (w/w), e.g. at least 60% (w/w), such as at least 70% (w/w), e.g. at least 80% (w/w), such as at least 85% (w/w), e.g. at least 90% (w/w), such as at least 95% (w/w), e.g. at least 98% (w/w).

During the gasification or reforming process in the production wellbore the reactor (4) co-produces carbon monoxide (CO) and/or carbon dioxide (CO₂) and this together with carbon monoxide (CO) and/or carbon dioxide (CO₂) that may be naturally present in the hydrocarbon composition are referred to as the internal CO₂ which may be captured (by carbon capture) and injected via the carbon dioxide-outlet (CO₂-outlet) (10) into the sub-surface reservoir (2) and stored. The carbon capture process of the internal CO₂ may be improved by adding sodium hydroxide (NaOH), via the sodium hydroxide-inlet (NaOH-inlet) (9) into the reactor (4) allowing the sodium hydroxide (NaOH) to react with the carbon monoxide (CO) and/or carbon dioxide (CO₂) forming carbonates and bicarbonates that may eventually precipitate in the sub-surface reservoir (2). The reactor has the capability to control the size of crystallisation sites and so control precipitation rates.

External carbon monoxide (CO) and/or carbon dioxide (CO₂) may be that carbon monoxide (CO) and/or carbon dioxide (CO₂) injected from above surface into the injection wellbore.

The composition comprising hydrogen (H₂) may be transferred to the processing rig comprising various surface facilities (5) or surface equipment that receives the hydrocarbon composition flow stream exiting the wellbore at surface. This surface facility (5) may comprise processes to aid in; separation (into constituents), chemical or physical treatment, compression, or additional pumping of the hydrocarbon composition & it's constituents to storage, further processing or export & sale.

Oil, hydrogen (H₂) and methane (CH₄), may be separated from the composition comprising hydrogen (H₂) distributed via a network of pipes and tanks, e.g. for export (11).

A well with one, or more than one, wellbore may also provide a second wellbore comprising a second reactor (4) shown on the right-hand side in FIG. 5. The second reactor (4) may be provided with at least one carbon dioxide-inlet (CO₂-inlet) (6), providing an externally supplied source of carbon dioxide (CO₂) and/or carbon monoxide (CO) to the reactor (4) in the wellbore. For the geothermal option, hydrocarbons may also be injected from above surface, and co-mingled (6) with the carbon dioxide (CO₂) and/or carbon monoxide (CO), to the reactor (4) in the wellbore. In addition, the reactor may be provided with a sodium hydroxide-inlet (NaOH-inlet) (9) for introducing sodium hydroxide (NaOH) into the reactor improving carbon capture of the carbon dioxide (CO₂) and/or carbon monoxide (CO). From the second reactor (4) a mixture of carbon dioxide (CO₂) and/or carbon monoxide (CO) from the externally supplied source—also called external CO₂— and/or internal CO2, may be injected into the sub-surface reservoir (2) via the carbon dioxide-outlet (CO₂-outlet) (10). This process also generates a composition comprising hydrogen (H₂) within the reactor which may be collected from the at least one hydrogen-outlet (H₂-outlet) (7).

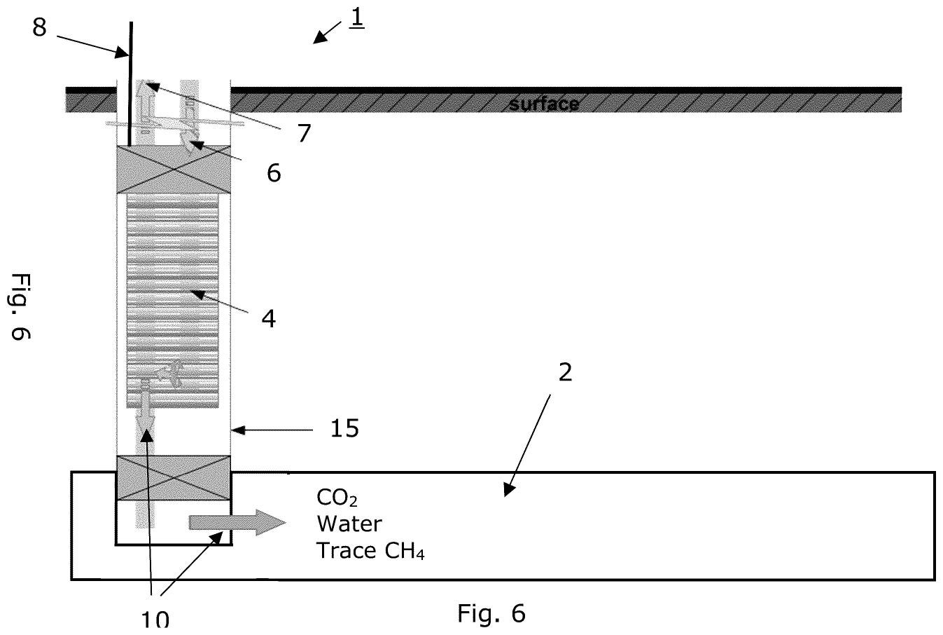

FIG. 6 shows part the system (1) according to the present invention, however, the processing rig, which forms part of the system and being in fluid contact with the reactor (4) is not shown in the figure. The reactor (4) may be placed in a wellbore (15) between the surface and a geothermal reservoir (such as a sub-surface geothermal reservoir) (2) and may be capable of converting a composition comprising a hydrocarbon composition and/or a carbon dioxide (CO₂) composition both supplied from above the surface (6) and/or the externally supplied source of carbon monoxide (CO) and/or carbon dioxide (CO₂) to hydrogen (H₂) taking advantage of the geothermal energy of the geothermal reservoir (2).

Together with the injection of a composition comprising a hydrocarbon composition and/or a carbon dioxide (CO₂) composition supplied from above the surface (6), water may be injected into the reactor (4).

The composition comprising a hydrocarbon composition and/or a carbon dioxide (CO₂) composition may be transported from above the surface into the reactor (4) via the via the carbon dioxide-inlet (CO₂-inlet) (6). The reactor may be placed in a wellbore sub-surface below the processing rig. Preferably, the reactor may be placed in the wellbore (15) close to the reservoir (2).

In the reactor (4) gasification or reforming of the composition comprising a hydrocarbon composition and/or a carbon dioxide (CO₂) composition may be performed and a composition comprising hydrogen (H₂) may be provided. The composition comprising hydrogen (H₂) may leave the reactor (4) via at least one hydrogen-outlet (H₂-outlet) (7). The hydrogen (H₂) or the composition comprising hydrogen (H₂) may be collected from the at least one hydrogen-outlet (H₂-outlet) (7).

Carbon dioxide (CO₂) and/or carbon monoxide (CO) produced in the reactor (4), e.g. from gasification or reforming and/or electrolysis, may be captured and either recycled into the reactor (4) or introduced into the sub-surface geothermal reservoir (2) via the carbon dioxide-outlet (CO₂-outlet) (10) preventing them reaching the atmosphere—thus resulting in a carbon capture process of the carbon dioxide (CO₂) originally present in the composition comprising a hydrocarbon composition and/or a carbon dioxide (CO₂) composition or the carbon dioxide (CO₂) co-produced during the conversion process.

The composition supplied to the reactor (4) via the carbon dioxide-inlet (CO₂-inlet) (6) may comprise a combination of CO₂ and methane (CH₄) and this combination may further improve/increase the productivity of the conversion of the hydrocarbon composition at least partly into a composition comprising hydrogen (H₂). The reason for this improved conversion of the hydrocarbon composition at least partly into a composition comprising hydrogen (H₂) may be caused by the balancing of the collective equilibrium of the gasification or reforming reactions:

CₙH₍₂ₙ₊₂₎+CO₂⇄H₂+CO+H₂O

The temperature necessary for the gasification or reforming reaction to take place may be in the range of 600-1200° C. To provide a temperature in the range of 600-1200° C. in order for the gasification or reforming reaction to take place requires a large amount of energy. Preferably the energy may be provided from geothermal energy, however additional electrical energy may be necessary to ensure sufficient energy for adjusting and maintaining the desired temperature and/or for reaching the minimum activation energies to initiate the exothermic reactions. These exothermic chemical gasification or reforming reactions may be sufficient to maintain the reactor temperatures once gasification or reforming commences. If the wellbore temperature and pressure are sufficient for the water and/or CO₂ to reach their supercritical phase this may lower the overall energy requirements for the gasification or reforming and improve energy efficiencies.

The electrical energy, as well as the electricity provided and necessary for the electrolysis and reactor, may be provided from the processing rig and may be produced from green energy, like wind power, wave or ocean current power, or the like. The electricity may be provided to the reactor from the processing rig by an electric cable (8). This electric cable (8) may also serve to export excess energy from the reactor to surface when required.

The remaining carbon dioxide (CO₂) not reacted in the gasification or reforming reaction may, together with e.g. trace amounts of carbon monoxide (CO) and remaining trace methane (CH₄) and water, be injected, via the carbon dioxide-outlet (10) into the reservoir. After this reinjection into the sub-surface geothermal reservoir any trace carbon monoxide (CO) may react with water, at about 180-500° C., forming hydrogen (H₂) and carbon dioxide (CO₂) following the following water gas shift reaction (WGSR):

CO+H₂O⇄H₂+CO₂

From this reaction additional hydrogen (H₂) may be formed which may be retained within and later recovered from the sub-surface geothermal reservoir (2).

The energy necessary to provide a temperature in the range of 180-500° C. in order for the water gas shift reaction (WGSR) to take place may preferably be provided from the reservoirs own geothermal energy.

### REFERENCES

(1): system
(2): sub-surface reservoir
(3): hydrocarbon-inlet
(4): reactor
(5): surface facility
(6): carbon dioxide-inlet (CO₂-inlet) from an externally supplied source
(7): at least one hydrogen-outlet (H₂-outlet)
(8): electric cable
(9): sodium hydroxide-inlet (NaOH-inlet)
(10): carbon dioxide-outlet (CO2-outlet)
(11): distribution network of pipelines and tanks, e.g. for export
(13): Reaction chamber
(14): concentric elements
(15) wellbore
(16): proton exchange medium
(17): energy unit
(18): jacket
(19): perforations at the hydrocarbon composition inlet
(20): separate zones of the reactor
(21): pumps, turbines, turbo-expanders, spargers or the like

1. A reactor comprising a reaction chamber surrounded by a jacket, said reaction chamber comprises at least one carbon dioxide-inlet (CO₂-inlet), and/or at least one hydrocarbon-inlet, and at least one hydrogen-outlet (H₂-outlet).

2. The reactor according to claim 1, wherein the reactor further comprising at least one carbon dioxide-outlet (CO₂-outlet).

3. The reactor according to claim 1, wherein the at least one hydrogen-outlet (H₂-outlet) and at least one carbon dioxide-outlet (CO₂-outlet) and/or the at least one hydrocarbon-inlet are separated by at least one proton exchange medium.

4. The reactor according to claim 1, wherein the reactor is adapted to be placed and used in a wellbore.

5. The reactor according to claim 1, wherein the reactor includes means for performing electrolysis and/or means for performing gasification or reforming of the hydrocarbon composition.

6. The reactor according to claim 1, wherein the reactor comprises an electrochemical cell.

7. The reactor according to claim 1, wherein the reactor is a Taylor-Couette Reactor.

8. A system for producing a composition comprising hydrogen (H₂), the system comprising a processing rig, the processing rig comprises a reactor, the reactor which converts a hydrocarbon composition and/or a carbon dioxide (CO₂) composition at least partly into a composition comprising hydrogen (H₂).

9. The system according to claim 8, wherein the hydrocarbon composition is provided to the reactor from a sub-surface reservoir and/or from above surface.

10. The system according to claim 8, wherein the carbon dioxide (CO₂) composition is provided to the reactor from a sub-surface reservoir and/or from above surface

11. The system according to claim 8, wherein the reactor converting the hydrocarbon composition and/or the carbon dioxide (CO₂) composition at least partly into a composition comprising hydrogen (H₂) is a reactor comprising a reaction chamber surrounded by a jacket, said reaction chamber comprises at least one carbon dioxide-inlet (CO₂-inlet), and/or at least one hydrocarbon-inlet, and at least one hydrogen-outlet (H₂-outlet).

12. The system according to claim 8, wherein the reactor is at least 100 meters sub-surface, such as at least 150 meters sub-surface, e.g. at least 250 meters sub-surface, such as at least 500 meters sub-surface, e.g. at least 750 meters sub-surface, such as at least 1000 meters sub-surface, e.g. at least 1500 meters sub-surface, such as at least 2000 meters sub-surface, e.g. at least 2500 meters sub-surface, such as at least 5000 meters sub-surface.

13. A method for producing a composition comprising hydrogen (H₂), the method comprises the steps of:
(i) providing a starting composition, wherein the starting composition comprises a hydrocarbon composition and/or a carbon dioxide (CO₂) composition; and
(ii) subjecting the starting composition provided in step (i) to a conversion reaction in a wellbore resulting in a composition comprising hydrogen (H₂)

14. The method according to claim 13, wherein the conversion reaction resulting in a composition comprising hydrogen (H₂), and a composition comprising carbon monoxide (CO) and/or carbon dioxide (CO₂) is performed in a reactor comprising a reaction chamber surrounded by a jacket, said reaction chamber comprises at least one carbon dioxide-inlet (CO₂-inlet), and/or at least one hydrocarbon-inlet, and at least one hydrogen-outlet (H₂-outlet).

15. The method according to claim 14, wherein the conversion reaction resulting in a composition comprising hydrogen (H₂), and a composition comprising carbon monoxide (CO) and/or carbon dioxide (CO₂) is performed, and wherein the resulting composition comprising carbon monoxide (CO) and/or carbon dioxide (CO₂) is injected from the reactor and further into the reservoir. The method comprises the steps of:
(i) providing a starting composition, wherein the starting composition comprises a hydrocarbon composition and/or a carbon dioxide (CO₂) composition;
(ii) subjecting the starting composition provided in step (i) to a conversion reaction resulting in a composition comprising hydrogen (H₂) and a composition comprising carbon monoxide (CO) and/or carbon dioxide (CO₂); and
(iii) injecting the composition comprising carbon monoxide (CO) and/or carbon dioxide (CO₂) directly into a reservoir.

16. A method of converting a hydrocarbon composition and/or a carbon dioxide (CO₂) composition at least partly into a composition comprising hydrogen (H₂), the method comprising providing geothermal energy (i.e., pressure and/or temperature corresponding to depth) in a wellbore as an energy source to assist with the conversion of the hydrocarbon composition and/or the carbon dioxide (CO₂) composition at least partly into the composition comprising hydrogen (H₂).
